(19) United States
(12) Patent Application Publication
(10) Pub. No.: US 2008/0172891 A1
(43) Pub. Date: Jul. 24, 2008

(54) Hand-held circular saw

(76) Inventor: Fangjie Nie, Nanjing (CN)

Correspondence Address: MCDERMOTT, WILL & EMERY LLP, 227 WEST MONROE STREET, SUITE 4400, CHICAGO, IL, 60606-5096, US

(21) Appl. No.: 11/893,626

(22) Filed: Aug. 16, 2007

(30) Foreign Application Priority Data
Aug. 17, 2006 (CN) 200620076808.9

(51) Int. Cl. B27B 9/02

(52) U.S. Cl. 30/376

(57) ABSTRACT

The invention provides a hand-held circular saw comprising a base plate and a cutting unit pivotally mounted on the base plate. The cutting unit includes a saw blade, a motor driving the saw blade, and a fixed guard covering at least a part of the saw blade. A guide plate with an arc-shaped slot extends from the base plate. A connecting member or bracket has a first end that is mounted to the cutting unit and a body portion operably connected to the guide plate by a locking element, namely a bolt, and a lever. Once released, the lever allows for movement of the bracket and the blade with respect to the guide plate. A stopper is mounted on the guide plate and is movable between a first position and a second position. In the first position, at least a part of the stopper intercepts the arc-shaped slot and stops the bolt from moving further within the arc-shaped slot. In the second position, at least a part of the stopper does not contact the bolt whereby the bolt is free to move within the slot and the bracket is fully adjustable.

### CROSS-REFERENCE TO RELATED APPLICATION

This application claims priority under 35 U.S.C. § 119 of Chinese Application 200620076808.9, filed Aug. 17, 2006, and is hereby incorporated by reference

### FEDERALLY SPONSORED RESEARCH OR DEVELOPMENT

Not Applicable.

### TECHNICAL FIELD

The present invention relates to a power saw with a circular saw blade, and specially, it relates to a circular saw which has a bevel adjusting device.

### BACKGROUND OF THE INVENTION

An electric cutting tool, such as a handle-held, portable circular saw, generally comprises a base plate adapted to lie on a workpiece and a cutting unit supported on the base plate. The cutting unit comprises a circular saw blade. The cutting unit is pivotably connected to the base plate through a front bracket and a rear bracket which are fixedly connected to two ends of the cutting unit respectively. A guiding plate formed with an arc-shaped slot thereon extends upwardly from the base plate. The arc-shaped slot is centered with the pivot axis of the cutting unit. One of the brackets comprises an extended arm which is connected to a locking element. The locking element passes through the arc-shaped slot and is movable therealong. An adjustable bevel cutting angle is defined as the angle between the blade and a reference line, that typically extends perpendicularly downward from the base plate. When it is desired to change the bevel angle, the cutting unit is pivoted relative to the base plate which subsequently moves the locking element along the arc-shaped slot. When the desired bevel angle is obtained, the locking element can be locked at the proper position. Thereafter, cutting of the workpiece with a desired bevel angle can be performed.

However, sometimes it is necessary to adjust the bevel angle within a certain narrow range, for example from 45° to 50°. For this objective, traditionally, a movable detent pin is mounted on the guiding plate, which can be pressed to the guiding plate by a locking screw. When it is necessary to adjust the bevel angle, the screw can be loosened by a screwdriver or other tools, and then the detent pin can be moved. After the detent pin is moved to the desired position, it can be locked by tightening the screw. This process may need to be repeated if the initial adjustment was imprecise or requires further tweaking. Accordingly, this adjustment process involves multiple steps and is time consuming.

The present invention is provided to solve these limitations and to provide advantages and aspects not provided by conventional power tools, including circular saws. A full discussion of the features and advantages of the present invention is deferred to the following detailed description, which proceeds with reference to the accompanying drawings.

### SUMMARY OF THE INVENTION

An object of the present invention is to provide a hand-held circular saw with an improved and compact bevel adjusting device, such that it is convenient and efficient to adjust the bevel angle of the saw blade.

To obtain the above objective, a hand-held circular saw according to the present invention comprises a base plate adapted to lie on a workpiece, a cutting unit, namely a saw blade, pivotally mounted on the base plate, a motor for driving the saw blade and a fixed guard that covers at least a portion of the saw blade. The circular saw further comprises a guiding plate extending from the base plate, wherein an arc-shaped slot is defined on the guiding plate. A connecting member has a first end fixedly connected to the cutting unit (the blade) and is moveable about a pivot axis of the cutting unit therewith. A second end of the connecting member is mounted with a locking means, wherein the locking means is movable along the arc-shaped slot. Further, a positioning device disposed on the guiding plate includes a stopper which is pivotal between a first position and a second position. In the first position at least a portion of the stopper is located in the arc-shaped slot and in the second position at least a portion of the stopper is located outside the arc-shaped slot.

With the aforementioned hand-held circular saw, the bevel angle of the cutting unit can be changed within a narrow range in an efficient and convenient manner.

### BRIEF DESCRIPTION OF THE DRAWINGS

The advantages and novel features of the present invention will become apparent from the following detailed description of the preferred embodiment of the invention illustrated in the accompanying drawings, wherein:

FIG. 1 is a front view of a hand-held circular saw of the present invention;

FIG. 2 is an exploded view of a portion of the hand-held circular saw in FIG. 1;

FIG. 3 is a front view of the hand-held circular saw in FIG. 1, wherein the bevel angle is approximately 45°; and

FIG. 4 is a front view of the hand-held circular saw in FIG. 1, wherein the bevel angle is approximately 50°.

### DESCRIPTION OF THE PREFERRED EMBODIMENT

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

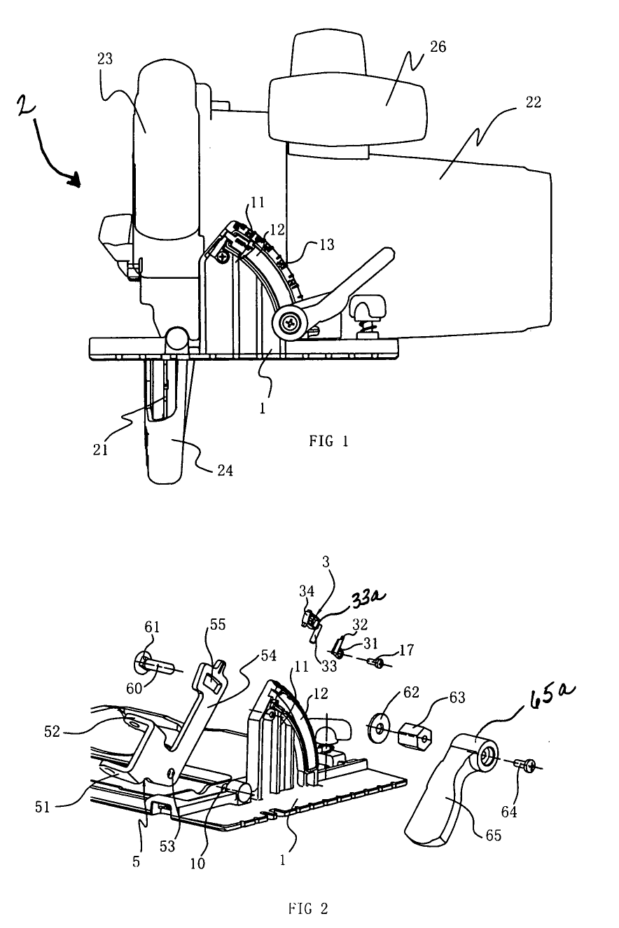

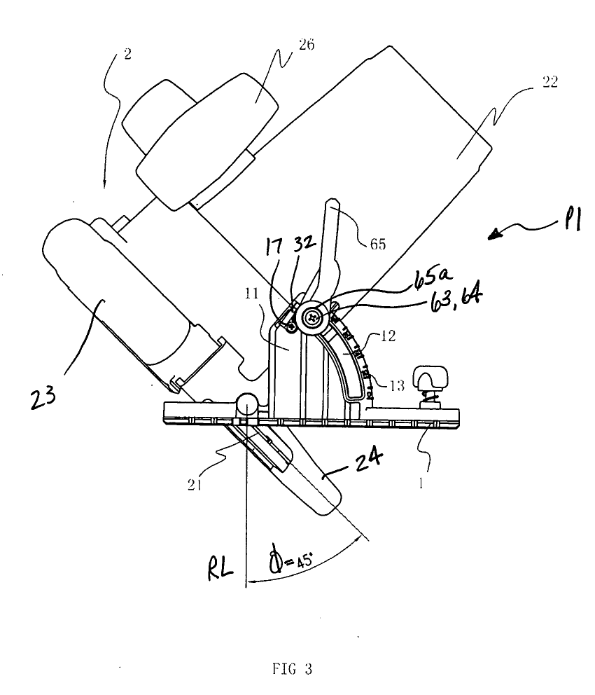

A hand-held circular saw of a preferred embodiment according to the present invention is described with reference to FIG. 1 to 4. The saw 10 includes a base plate 1 that engages or lies upon a workpiece that is cut during operation. An electric cutting unit 2 is supported on the upper surface of the base plate 1, and comprises a circular saw blade 21, a motor 22 for driving the saw blade 21, a fixed upper guard 23 that covers the upper half of the saw blade 21 and a handle 26 which is mounted on a motor housing 22a. The electric cutting unit 2 may further comprise a movable lower guard 24 for covering the lower half of the saw blade 21. During operation, the workpiece forces the movable guard 24 back towards the handle 26 and housing 22a to expose the leading edge of the saw blade 21. The electric cutting unit 2 is pivotally mounted on the base plate 1 through a front bracket assembly 5 (see FIG. 2) and a rear bracket (not shown) which are fixedly connected to the front and rear ends of the electric cutting unit 2 respectively.

The front bracket assembly 5, as shown in the exploded view of FIG. 2, comprises a first arm 51 and a second arm 52 which are substantially parallel to each other and fixedly connected to the cutting unit 2. The first and second arms 51, 52 extend, substantially perpendicular, from an elongated main body portion 54. The front bracket 5 is formed with an aperture 53 below the first and second fixing arm 51, 52. The front bracket 5 is pivotally mounted on the base plate 1 by engagement with a shaft 10 via the aperture 53, wherein the shaft 10 is affixed to the base plate 1. The rear bracket, which is not shown in the drawings, pivotally mounts the cutting unit 2 on the base plate 1 in the same or similar manner.

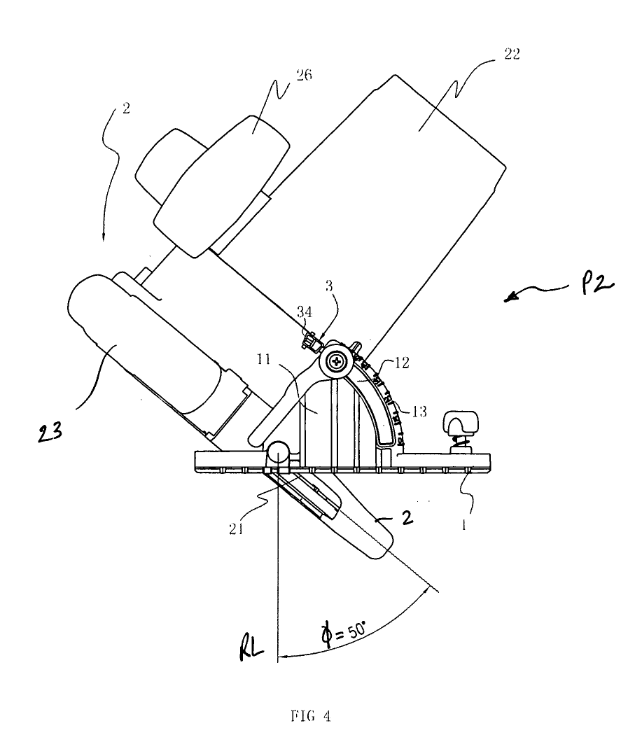

Referring to FIG. 2, a curvilinear or fan-shaped guide plate 11 extends upwardly from the base plate 1 and is formed with an arcuate slot 12 centered about the axis of the shaft 10 and an angle scale 13 corresponding to the slot 12. A locking element, namely a bolt 60 with a rectangular portion 61, is engaged within a cooperatively dimensioned rectangular hole 55 of the body portion 54. An elongated, preferably threaded, portion of the bolt 60 passes through the arc-shaped slot 12 of the guide plate 11 and secured with a washer 62 and a nut 63 to operably connect the body portion 54, namely the upper end of the arm 54, to the plate 11. A lever 65 is fixedly connected to the nut 63 via a fastener 64, wherein an extent of the fastener bolt 64 and the nut 63 reside within a collar 65a of the lever 65. The bolt 60, the nut 63, the fastener 64 and the lever 65 collectively define a releasable locking assembly for the guide plate 11 and the arm 54. When the operator actuates the lever 65 and the nut 63 rotates, the extended arm 54 of the front bracket 5 can be alternatively locked or released relative to the guide plate 11 expediently. The releasing of the arm 54 relative to the guide plate 11 enables an operator to adjust the beveled cutting angle Φ of the blade 21 (see FIG. 3), which is the angle between the blade 21 and a reference line RL that extends perpendicularly downward from the base plate. The bolt 60 moves within the slot 12, however, when the bolt 60 engages the lower end of the slot 12, the saw blade 21 is perpendicular to the base plate 1 and the beveled cutting angle Φ is substantially 0 degrees. In this situation, the angle between the blade 21 and the base plate is substantially 90 degrees.

In most cases, the maximum beveled cutting angle Φ for a circular saw is 45 degrees (see FIG. 3), which is frequently used by the operator. However, a larger beveled cutting angle Φ such as 50 degrees may be desired due to the geometry of the workpiece. In order to change between the two cutting bevel angles quickly and accurately, an angle adjustment device, configured as a tab or stopper 3, is pivotally mounted on the guide plate 11 and adjacent to the upper end of the slot 12. The stopper 3 also includes a fixing member 31 with a fixing portion 32 having a half-ring cross section. The fixing member 31 is fixed on the guide plate 11 adjacent to the upper end of the slot 12 via a bolt 17, such that a receiving space or cavity is formed between the fixing portion 32 and the guide plate 11. The stopper 3 also comprises a rod 33 which is pivotally received in the receiving space.

The stopper 3 has a first side portion 33a adjacent to the rod 33, and a second side portion 34 apart from the rod 33. When the stopper 3 is turned to a first position P1 (see FIG. 3), the second side 34 enters or intercepts the slot 12 to prevent the bolt 60 from proceeding further up the slot 12 and to abut the upper end of the slot 12, and the edge of the second side 34 is directed to an angle of 45°. In the first position P1, the bolt 60 is precluded from traveling the full length of the slot 12, including the uppermost region of the slot 21. At this time, the cutting unit 2 can be adjusted from the vertical cutting position (cutting angle Φ=0 degrees) as shown in FIG. 1 to the beveled cutting angle Φ of 45 degrees as shown in FIG. 3 quickly and accurately. When the stopper 3 is turned to a second position P2 (see FIG. 4), the second side 34 is located beyond or outside of the slot 12 and the stopper does not interact with the bolt 60. Since the second side 34 is located beyond the slot 12 and does not restrict movement, the cutting unit 2 can be pivoted further to the maximum beveled cutting angle Φ of 50 degrees (as shown in FIG. 4).

According to the present invention, the angle adjustment device, namely the stopper 3, provides for simple and rapid adjustment of beveled cutting angle Φ. Besides the above disclosed embodiment, the present invention may include other embodiments. For example, the guide plate 11 may be mechanically connected to the base plate 1 instead of being integrated with the base plate, the guide plate may be connected to the rear bracket, the guide plate may comprise several arc-shaped slots, there may be other locking means for locking or releasing the extended arm and the guide plate, the pivotal stopper may be formed with other shapes, and the maximum bevel angle may be other angles, and etc. Those skilled in the art will understand that the hand-held circular saw of the present invention may comprise other substitutions and modifications according to the spirit of the present invention.

What is claimed is:

1. A hand-held circular saw comprising:
a base plate adapted to contact a workpiece during operation;
a cutting unit pivotally mounted to the base plate;
a guide plate extending upward from the base plate and having an arcuate slot;
a bracket pivotally mounted on the base plate, the bracket having a first end connected to the cutting unit and a body portion operably connected to the guide plate by a bolt extending through the slot in the guide plate; and
a stopper pivotally mounted to the guide plate and being adjustable between a first position wherein at least a part of the stopper intercepts the arcuate slot to prevent the bolt from traveling the full length of the slot, and a second position wherein the stopper does not intercept the slot and does not interact with the bolt whereby the bolt can travel the full length of the slot.

2. The circular saw of claim 1, further comprising a lever joined to the bolt, wherein an operator actuates the lever to move the bolt within the slot to allow for adjustment for the bracket.

3. The circular saw of claim 2, further comprising a nut and a fastener for securement of the bolt to the lever, and wherein the bolt, the nut, the fastener and the lever collectively define a releasable locking assembly.

4. The circular saw of claim 1, wherein the body portion of the bracket has a hole and the bolt extends through the hole and into the slot of the guide plate.

5. The circular saw of claim 1, wherein the body portion of the bracket has an aperture that is pivotally connected to a shaft of the base plate.

6. The circular saw of claim 1, wherein the cutting unit includes a saw blade, the saw blade and a reference line extending perpendicularly downward from the base plate to define a beveled cutting angle, and wherein an operator actuates the lever to move the bracket and the bolt with respect to the guide plate for adjustment of the beveled cutting angle.

7. The circular saw of claim 6, wherein in the first position, the stopper prevents the bolt and the lever from traveling the full length of the slot during adjustment of the cutting angle, and in the second position, the stopper is located beyond the slot whereby the bolt and the lever can travel the full length of the slot during adjustment of the cutting angle.

8. A portable circular saw comprising:
a base plate that contacts a workpiece during operation;
a guide plate extending upward from the base plate and having an arc-shaped slot;
a cutting unit comprising a saw blade and a motor driving the saw blade;
a front bracket that operably connects the cutting unit to the base plate, the front bracket having at least one arm that extends from a body portion and that is secured to the cutting unit, and wherein the body portion is operably connected to the guide plate by a bolt; and,
a stopper pivotably mounted adjacent to an upper end of the guide plate, and being pivotal between a first position wherein a portion of the stopper enters the slot to prevent the bolt from traveling the full length of the slot, and a second position wherein the stopper resides beyond the slot.

9. The circular saw of claim 8, wherein the body portion of the bracket has a hole and the bolt extends through the hole and then into the slot of the guide plate.

10. The circular saw of claim 8, wherein the body portion of the bracket has an aperture that is pivotally connected to a shaft of the base plate.

11. The circular saw of claim 8, further comprising a lever joined to the bolt, wherein an operator actuates the lever to move the bolt within the slot to allow for adjustment for the bracket.

12. The circular saw of claim 8, further comprising a nut and a fastener for securement of the bolt to the lever, and wherein the bolt, the nut, the fastener and the lever collectively define a releasable locking assembly the guide plate and the bracket.

13. The circular saw of claim 8, wherein the saw blade and a reference line extending perpendicularly downward from the base plate to define a beveled cutting angle, and wherein an operator actuates the lever to move the bracket and the bolt with respect to the guide plate for adjustment of the beveled cutting angle.

14. The circular saw of claim 13, wherein in the first position, the stopper prevents the bolt and the lever from traveling the full length of the slot during adjustment of the cutting angle, and in the second position, the stopper is located beyond the slot whereby the bolt and the lever can travel the full length of the slot during adjustment of the cutting angle.

15. A portable, hand-held circular saw comprising:
a base plate adapted to contact a workpiece during operation, the base plate having an upwardly extending guide plate with an arcuate slot;
a cutting unit pivotally mounted to the base plate, the cutting unit having a saw blade and a motor, wherein the saw blade and a reference line extending perpendicularly downward from the base plate define a beveled cutting angle;
a bracket pivotally mounted on the base plate, the bracket having a first arm connected to the cutting unit and a body portion operably connected to the guide plate by a bolt and a lever, wherein an operator actuates the lever to move the bracket and the bolt with respect to the guide plate for adjustment of the blade bevel angle; and,
a stopper pivotally mounted to the guide plate, wherein in a first position the stopper enters the slot to prevent the bolt and the lever from traveling the full length of the slot during adjustment of the blade bevel angle, and in a second position the stopper is located beyond the slot whereby the bolt and the lever can travel the full length of the slot during adjustment of the blade bevel angle.

16. The circular saw of claim 15, wherein the bracket has a second arm connected to the cutting unit.

17. The circular saw of claim 15, wherein the body portion of the bracket has a hole and the bolt extends through the hole and into the slot of the guide plate.

18. The circular saw of claim 15, further comprising a nut and a fastener for securement of the bolt to the lever, and wherein the bolt, the nut, the fastener and the lever collectively define a releasable locking assembly the guide plate and the bracket.

19. The circular saw of claim 15, wherein the body portion of the bracket has an aperture that is pivotally connected to a shaft of the base plate.

20. The circular saw of claim 15, wherein the stopper comprises a fixing member, a rod, a first side portion and a second side portion, and wherein the second side portion enters the slot in the first position to prevent further movement of the bolt.

21. The circular saw of claim 20, wherein the second side portion is beyond the slot in the second position and does not interact with the bolt.
